(19) United States
(12) Patent Application Publication
(10) Pub. No.: US 2017/0159828 A1
(43) Pub. Date: Jun. 8, 2017

(54) FLUID CIRCULATION VALVE, IN PARTICULAR FOR A MOTOR VEHICLE, WITH THRUST WASHER AND METHOD FOR MANUFACTURING SUCH A VALVE

(71) Applicant: Valeo Systemes de Controle Moteur, Cergy Saint Christophe (FR)

(72) Inventors: Michael Sanches, Le Plessis-Trevise (FR); Guillaume Davoult, Cergy (FR); Thierry Lanoe, Osny (FR)

(73) Assignee: Valeo Systemes de Controle Moteur, Cergy Saint Christophe (FR)

(21) Appl. No.: 15/327,493

(22) PCT Filed: Jul. 20, 2015
(86) PCT No.: PCT/FR2015/051995

§ 371 Date: Jan. 19, 2017

(30) Foreign Application Priority Data
Jul. 23, 2014 (FR) 1457086

(51) Int. Cl. F16K 1/22; B23P 15/00

(52) U.S. Cl. CPC F16K 1/224; B23P 15/001

(57) ABSTRACT

The invention relates to a fluid circulation valve for a motor vehicle, including a valve body (2) having a conduit (3), a flap (5) closing off the conduit (3) fastened on a shaft (4), a rotary control member (21) of the shaft (4), fastened at a proximal end (12) of the shaft (4) and the rotation of which selectively commands the opening and closing of the conduit (3) by the closing flap (5), and a torsional return spring (42) of the control member (21), a stop (76) being provided at one distal end (11) of the shaft (4), opposite the proximal end (12), to keep the closing flap (5) in the axial position in the conduit (3) by cooperation with the valve body (2), against a force of the return spring (42), the stop (76) including a flat washer (102) fastened on the lateral end (11) of the shaft (4).

The present invention relates to a fluid circulation valve, in particular for a motor vehicle, and a method for manufacturing such a valve.

It is particularly intended for applications as an intake gas metering valve for internal combustion engines, whether they use gasoline or Diesel. It may also be applicable as an exhaust gas recirculation (EGR) valve. Other applications of the valve according to the invention are also possible without going beyond the scope of the invention.

Fluid circulation valves are known including a body having a fluid passage conduit, a flap, a freely rotating shaft on which the flap is fastened, and a rotating member for controlling the rotation of the shaft. The rotation of the flap makes it possible to adjust the fluid flow rate circulating in the conduit. The rotation of the control member and therefore the flap is controlled by an electric motor, against the action of a torsional return spring of the control member. The return spring keeps the control member in a predetermined opening and closing position of the valve, when the valve is not actuated.

The shaft is for example made up of a metal rod. The control member comprises a platen and a toothed sector made from plastic overmolded on the platen. The metal rod is made subject to the control member by forging one axial end of the rod in an orifice of the platen. Alternatively, the control member is overmolded on the metal rod.

At the opposite end of the shaft (hereinafter referred to as the distal end), it is known to form a stop intended to keep the shaft in position in the valve body, in cooperation with a pulling action of the torsional return spring, exerted on the shaft via the control member.

To that end, it is known to fasten a bent washer fitted, then welded on the cylindrical part of the shaft at the distal end of the shaft. Between this bent washer and the valve body, a stepped bearing may be arranged to guide the rotation of the shaft.

Such an embodiment of the stop has good resistance to friction and vibrations. However, it has a significant axial bulk.

Other assemblies have been proposed to keep the shaft in position in the valve body.

First, it has been proposed to produce a stop using a circlips inserted into a slot on the shaft, the circlips being sandwiched between two stationary parts, for example between a bearing and the valve body. In this case, the position of the shaft is ensured independently of the action of the return spring. Moreover, the slot may a priori be situated at any point of the shaft. Such a solution is compact and easy to assemble.

According to another proposed assembly, a stop at the distal end of the shaft is made using a pin fitted in the valve body and fastened at the distal end of the shaft.

In both cases, however, an expensive surface treatment is necessary to ensure that the assembly withstands vibrations and friction. The pin assembly also has a significant bulk.

The invention aims to offset the aforementioned problems and to that end proposes a fluid circulation valve, in particular for a motor vehicle, including a valve body having a passage conduit for a fluid, a flap closing off the conduit, a shaft on which the closing flap is fastened, a rotary control member of the shaft, fastened at a proximal end of the shaft and the rotation of which selectively commands the opening and closing of the conduit by the closing flap, and a torsional return spring of the control member, a stop being provided at one distal end of the shaft, opposite the proximal end, to keep the closing flap in the axial position in the conduit by cooperation with the valve body, against a force of the return spring, the stop including a flat washer fastened on the lateral end of the shaft.

Thus, according to the invention, the maintenance in position of the shaft in the valve body is ensured using a flat washer fastened on the lateral end of the shaft. Such a solution is in particular more compact than the known solution implementing a bent washer fitted at the end of the shaft. The solution proposed here also does not require any particular surface treatment.

According to various embodiments, which may be considered together or separately:
the lateral end on which the flat washer is fastened has a circular groove, the weld bead between the lateral end of the shaft and the flat washer being received in the groove.
the lateral end on which the flat washer is fastened has a centering lug, the groove preferably being formed at the base of the centering lug.
a distal bearing guiding the rotation of the shaft relative to the valve body is inserted between the flat washer and the valve body, the flat washer keeping the distal bearing in contact against the valve body.
the valve body has a shoulder forming a housing receiving the distal bearing.
the valve body comprises a proximal bearing guiding the rotation of the shaft relative to the valve body, opposite the flat washer relative to the closing flap, a seal preferably being arranged axially between the proximal bearing and the valve body.
the valve body comprises a bush guiding the rotation of the shaft relative to the valve body, with an integrated seal opposite the flat washer relative to the closing flap.

The invention also relates to a method for manufacturing a fluid circulation valve, in particular a valve for a motor vehicle, comprising the following steps:
a) molding a valve body having a conduit to be closed off using a closing flap,
b) inserting a shaft into the valve body so that the closing flap is received in the conduit, and
c) fastening a flat washer on a lateral end of the shaft opposite a control member.
the washer being welded on the lateral end of the shaft, the weld seam preferably being formed in a groove.
during the welding, a force pressing the washer on the valve body or a distal bearing and a force pressing the shaft on the flat washer are applied, the force pressing the flat washer on the valve body, or the distal bearing, being greater than the force pressing the shaft on the flat washer.
the method comprises a step for forming a centering lug on the lateral end of the shaft, intended to be the opposite end of the shaft relative to the control member, and a groove at the base of the lug.

The appended figures show how the invention can be carried out. In these figures, identical references designate similar elements.

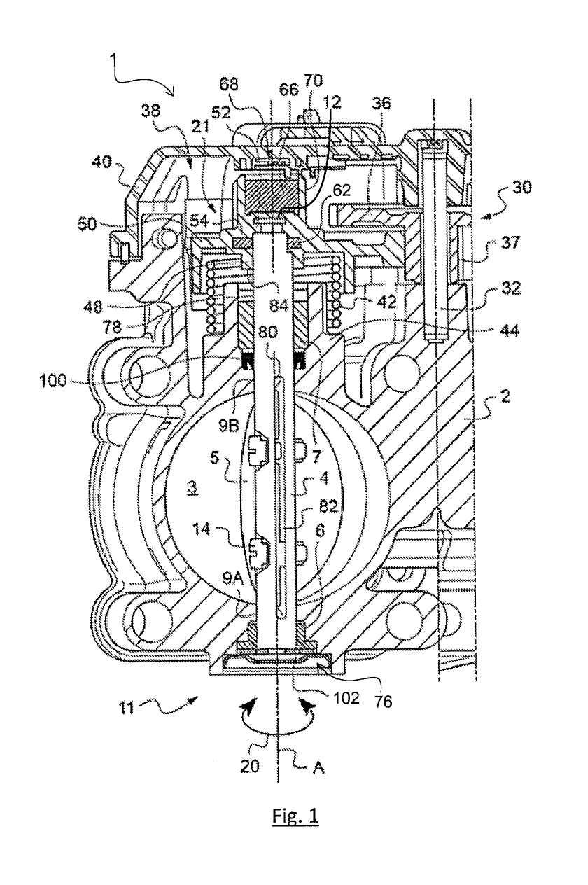

FIG. 1 is an axial sectional view of part of an example embodiment of a fluid circulation valve.

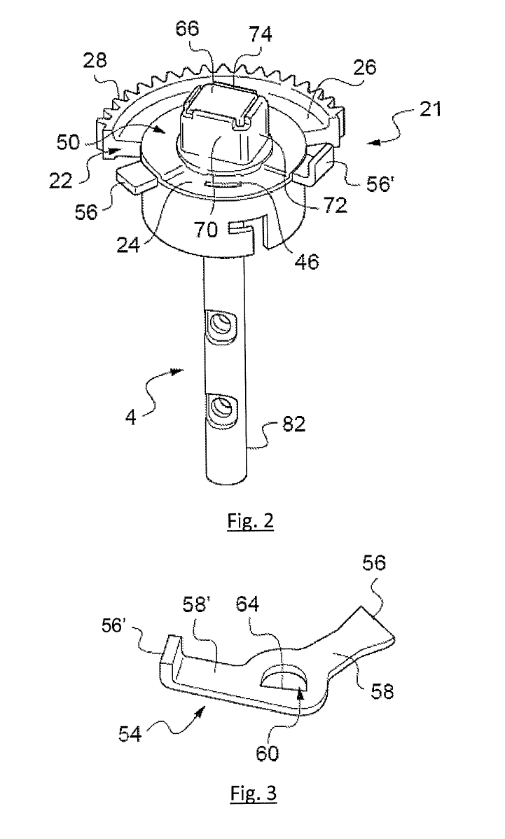

FIG. 2 is a perspective view of the assembly of the control shaft and the driving member of the valve of FIG. 1.

FIG. 3 is a perspective view of a platen of the driving member of FIG. 2.

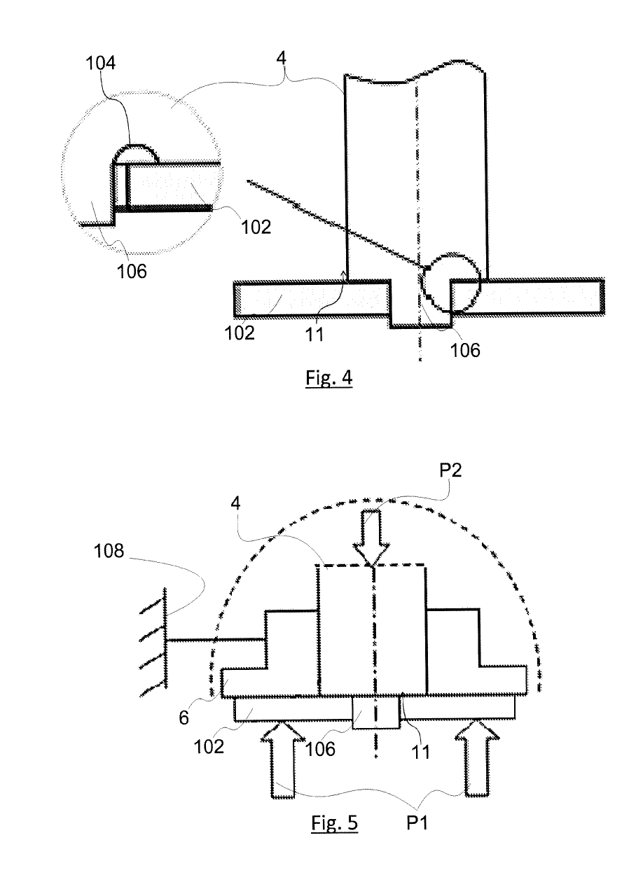

FIG. 4 is a diagrammatic sectional view of an enlargement of a detail of FIG. 1.

FIG. 5 illustrates the same detail as FIG. 4, during a step for manufacturing the valve of FIG. 1.

As illustrated in FIG. 1, the invention relates to a fluid circulation valve 1, in particular for a motor vehicle. Here, this is a valve for adjusting the intake gas flow rate of a heat engine, in particular a metering valve for a diesel engine.

The valve comprises a body 2 inside which a fluid circulation conduit 3 is arranged. The body 2 here is intended to be mounted, via couplers, on an intake line of the engine such that the part of the gases circulating in this bypass traverses the conduit and is oriented toward the engine to participate in the combustion. The couplers and the intake line have not been shown, since they are well known in themselves.

A shaft 4, freely rotating with a flap 5 secured thereto making it possible to close off the conduit 3 more or less based on the angular position of the shaft 4, as illustrated by the arrow 20 rotating around the longitudinal axis A of the shaft 4, are mounted in the body 2 of the valve 1, which is generally from foundry.

The shaft 4 is connected in rotation with the closing flap 5 by fastening members 14, here a screw-nut system, or the like, which allows the flap to rotate with the shaft between two extreme positions, one of which, completely open, like in FIG. 1, allows the fluid to pass, and the other of which, not shown, blocks its passage, the flap then being pressed against the lateral wall of the conduit 3.

The valve 1 for example further comprises pivot link means between the body 2 and the shaft 4, here two lower (or distal) 6 and upper (or proximal) 7 bearings, for the rotating movement of the shaft 4 relative to the longitudinal axis.

More particularly, two aligned holes 9A, 9B are arranged in the body 2, perpendicular to the conduit 3 passing diametrically through the latter, to form housings, with a circular section, for passage of the shaft 4. They respectively receive the pivot link means, i.e., the two bearings 6, 7. These are cylindrical with an annular section and, in this example, forcibly mounted in the holes 9A, 9B so as to be immobilized in position, in rotation and translation, relative to the body 2 of the valve. These fixed bearings 6, 7 are for example made from a material that ensures the appropriate self-lubricating and anti-corrosive properties imparting greater longevity. To that end, they can be made from an alloy of copper and nickel or tin, or a stainless steel.

In these two bearings 6, 7, the shaft 4 is received, which can thus pivot freely around the axis A, by a sliding adjustment provided between the shaft and the bearings. The end 11 of the shaft, described as lower relative to FIG. 1, engages in the corresponding bearing 6, while the other, upper end 12 traverses the other bearing 7 and emerges toward the outside of the body 2 of the valve 1 to be connected to a control member 21 for the rotation of the shaft 4.

As is more visible in FIG. 2, the control member 21 is for example a gear sector wheel 22 comprising a central part 24 centered on the shaft 4 and a radial protuberance 26, forming an angular sector slightly larger than the angular travel of the flap and provided with gear teeth 28.

Referring again to FIG. 1, the gear sector 22 here is connected in rotation to an idler wheel 30 freely rotating relative to the body 2 around a hinge pin 32 parallel to the longitudinal axis A of the shaft 4. The valve 1 further comprises an electric motor, not shown, in particular a stepping motor. The electric motor meshes on a large pinion 36 of the idler wheel 30, while the gear sector 22 meshes on a small pinion 37 of the latter. In this way, the actuation of the motor causes the idler wheel 30 to rotate, which in turn causes the rotation of the gear sector 22 and therefore the flap 5 via the shaft 4.

The control member 21, the intermediate wheel 30 and/or the motor are positioned in a housing 38 of the valve closed by a cover 40.

The valve may also comprise a torsion spring 42 making it possible to position the flap 5 in an idle position, here an open position. In other words, the torsion spring 42 is a spring returning the control member 21 to its position. The idle position refers to a position assumed when the motor of the valve is not actuated. The torsion spring 42 bears on the one hand on the body 2, here via an upper shoulder 44, and on a control member 21, via a slit 46 (FIG. 2). The torsion spring 42 is in particular centered on the longitudinal axis A.

Here, the control member 21 is overmolded on the shaft 4. In this way, these two parts are secured without play. They can be preassembled before mounting in the body 2.

The control member 21 is for example made from plastic and/or the shaft is for example made from metal, in particular stainless steel.

Here, the control member 21 comprises walls forming a well 48, extending axially beyond a wall 50 extending radially, in particular orthogonally to the shaft 4, and bearing the gear teeth 28. The control member is overmolded on the shaft 4 at the well 48. The shaft may further comprise a groove 52 in which the control member 4 is overmolded. The well 48 and/or the groove 52 contribute to effectively securing the control member 21 and the shaft.

The valve 1 may also comprise a platen 54, in particular made from metal, defining one or several radial stops 56, 56′ (FIGS. 2 and 3) defining an angular travel of the control member 21. More specifically, the platen 54 is connected in rotation to the shaft 4 and overmolded by the control member 21. Furthermore, in the extreme angular positions of the valve 1, the radial stops 56, 56′ come into contact with forms, not visible, arranged in the body 2 of the valve. The angular travel of the control member 21 is defined in this way. As better shown in FIG. 3, the platen 54 comprises two radial arms 58, 58′ respectively ending with radial stops 56, 56′.

The platen 54 further has, at the intersection of the arms 58, 58′, a passage orifice 60 for the shaft 4. The shaft 4 and the passage orifice 60 are mutually configured to transmit radial stop forces from the platen 54 to the shaft 4. To that end, here, the shaft 4 has a flat 62 (FIG. 1) and the passage orifice 60 has a straight portion 64. The shaft 4 is adjusted in the passage orifice 60 such that the flat 62 bears against the straight portion 64. The gear sector 22 is thus not biased upon impact when the platen 54 abuts against the body 2.

In reference again to FIGS. 1 and 2, one can see that the valve 1 further includes a sensor target 66. This is, for example, a magnetic sensor target, such as a flat magnet, i.e., a rectangular parallelepiped magnet whereof the two large faces are arranged perpendicular to the rotation axis A of the control member 21. The magnet 66 generates a magnetic field intended to influence a magnetic sensor 68, in particular a Hall effect sensor, here positioned on the cover 40 of the valve 1.

The flat magnet 66 is substantially a rectangular rhomb. It has two faces oriented orthogonally to the longitudinal axis A of the shaft 4. It is further centered on the longitudinal axis A. In this way, the flat magnet locally generates parallel field lines, in a plane orthogonal to the longitudinal axis A. Thus, the angular positioning of the control member 21 and therefore the position of the flap 5 correspond to an identical angular position of the field lines, which reliabilizes the measurement.

The valve 1 further comprises a housing 70 for receiving the sensor target 66. The housing 70 advantageously comes from molding of the control member 21 so as also to reduce the angular play between the moving parts of the valve 1. Such a method of producing the housing 70 also makes it possible to limit the number of operations necessary to manufacture the valve. The sensor target 66 is, however, inserted into the housing 70, after this housing 70 is formed. Thus, the housing 70 is not obtained by overmolding the sensor target 66. This makes it possible to avoid damaging the sensor target during the molding operation of the control member 21.

However, the housing 70 here is made up of four walls 72.

The housing 70 and the sensor target 66 preferably have complementary shapes, in particular rectangular rhomb shapes. The target sensor 66 is for example positioned flat on a bottom of the housing 70.

The walls 72 of the housing 70 further have a tongue 74, protruding along the rotation axis A of the control member 21. These tongues 74 are folded down on the sensor target 66 to maintain it in the housing 70, once the sensor target 66 is inserted into the housing 70.

The shaft 4 as illustrated in the figures also comprises an axial stop 76, situated at the end 11 of the shaft, opposite the control member 21 (i.e., opposite the end of the shaft 4 at which the control member 21 is fastened). Hereinafter, this end 11 is called the distal end of the shaft 4, in reference to the control member 21 that is fastened at the proximal end of the shaft 4. In this way, the assembly of the moving body formed by the control member 21 and the shaft 4 in the body 2 is made easier. Indeed, the longitudinal segment 78 of the shaft 4 extending from the closing flap 5 to the control member 21 then does not need to cooperate with an axial stop, the latter being provided in the distal part of the shaft 4. The segment 78 is subsequently referred to as the free zone. This axial stop 76 makes it possible to keep the closing flap 5 in axial position in the conduit 3, cooperating with the valve body 2, against a pulling force of the torsional return spring 42 on the shaft 4. This pulling force tends to remove the shaft 4 from the holes 9A and 9B.

The free zone 78 is more particularly situated here at an upper end 80 of a fastening slit 82 of the closing flap 5 at a lower end 84 of the well 48. In other words, the free zone 78 is situated at the passage 9B of the control shaft 4 toward the housing 38 accommodating the control member 21.

Here, the axial stop 76 comprises a flat washer 102, fastened on the distal lateral end 11 of the shaft 4, i.e., on the circular surface of this distal end 11 of the shaft 4, perpendicular to the axis A of the shaft 4. Using a flat washer 102 makes it possible to produce a stop with a small axial bulk. Fastening the flat washer 102 on the lateral end of the shaft makes it possible to avoid having to use expensive surface treatments.

The fastening of the flat washer 102 on the distal end 11 of the shaft 4 can in particular be done by welding. Preferably, the weld bead between the washer 102 and the distal end 11 of the shaft extends over an angular sector of 360°, the bead preferably also forming a circle. Of course, the weld bead may assume other forms; it may also be discontinuous.

To ensure the alignment of the washer 102, i.e., in particular that the axis of the washer is aligned with or at least parallel to the axis of the shaft, a groove may be provided on the surface of the distal end 11 of the shaft, this groove receiving the weld bead implemented to weld the washer 102 on the shaft 4. Thus, this weld bead does not involve an overthickness relative to the surface of the distal end 11 of the shaft 4 and the washer 102 rests substantially on the entire surface of the lateral end of the shaft not forming the groove.

Preferably, this groove 104 is, as shown in FIG. 4, made at the foot or base of a centering lug 106 formed on the surface of the lateral end 11 and intended to cooperate with the central opening in the washer 102 in order to center this washer 102 relative to the shaft 4. Advantageously, the centering lug 106 is formed by machining the distal end 11 of the shaft 4, this machining naturally forming a groove at the foot of the lug 106. The section of the groove 104 is shown here in the form of a half circle, but this section may have a different shape. In particular, the section of the groove may have a bevel on a radially outer part. The groove 104 also makes it possible to minimize the concentration of mechanical stresses in the shaft 4.

The axial stop 76 and the body 2 are advantageously mutually configured so as to axially block the washer 102 on the body 2 in a first direction, oriented toward the control member 21, the first direction corresponding to the direction of an axial force imparted to the shaft by the torsional spring 42.

Here, the bearing 6 is inserted between the washer 102 and the valve body 2. To ensure effective guiding of the shaft 4, this stepped bearing 6 here is received in a housing with a complementary shape formed by a shoulder in the valve body 102. The washer 102 keeps this bearing 6 against the valve body 2.

Furthermore, the valve is configured so that the axial stop is also axially blocked in a second direction, opposite the first direction.

As mentioned above and more visible in FIG. 2, the control member 21 comprises a slit 46. The latter accommodates one end of a torsion spring 42, not illustrated in this figure, but visible in FIG. 1. The slit 46 axially traverses the wall 50 of the control member 21. The slit 46 advantageously defines two catching positions for the torsion spring 42.

The slit 46 is for example oriented along an angular sector, centered on the longitudinal axis A of the shaft 4. In this way, the slit 46 defines a catching position of the torsion spring 42 at each of its angular ends.

The valve body is made prior to mounting the aforementioned parts in the valve body 2, for example by molding. The mounting of the parts may then be done as follows. A sealing gasket 100 and the upper 7 and lower 6 bearings are arranged in the body 2 respectively at respective shoulders, including the first shoulder. The upper bearing 7 and sealing gasket 100 assembly can alternatively be replaced by a guide bush of the shaft 4 with an integrated seal.

The moving assembly including the control member 21 and the shaft 4 is then mounted in the passage holes 9A, 9B while being inserted from top to bottom, the torsion spring 42 having been installed between the control member 21 and the body 2.

The washer 102 is then centered on the distal end 11 of the shaft using the centering lug 106, which is preferably machined on the shaft 4, before the latter is inserted in the valve body. The flat washer 102 is then fastened, in particular welded, on the surface of the distal end 11 of the shaft 4. In this case, the weld bead is formed in the groove 104, as mentioned above.

Preferably, during this step of welding the washer 102 on the distal end 11 of the shaft, the washer 102 undergoes a dual force:
a force P1 pressing the washer 102 on the bearing 6 (or on the valve body 2 when the bearing 6 is not present), and
a force P2 pressing the shaft 4 on the washer 102, such that P1>P2 in order for the washer to be constantly abutting against the bearing 6 (or the valve body 2 when the bearing 6 is not present). This dual force on the washer makes it possible to maximize the maintaining surface and optimize the perpendicularity of the flat washer 102 relative to the axis A of the shaft 4, once the flat washer 102 is welded.

A valve as described above is applicable in particular as a fluid circulation valve for a motor vehicle. In particular, such a valve can be used as an intake gas metering valve for internal combustion engines or an exhaust gas recirculation valve or an EGR valve.

The invention is not limited solely to the example embodiment described above in light of the figures, for information and non-limitingly.

In particular, the groove 104 can be made at any radial level on the surface of the distal end 11 of the shaft 4, even though the illustrated groove has the advantage of not requiring an additional operation to be made, since it is formed naturally by machining the distal end 11 of the shaft 4 to form the centering lug 106.

1. A fluid circulation valve for a motor vehicle, comprising:
a valve body having a passage conduit for a fluid;
a flap closing off the conduit;
a shaft on which the closing flap is fastened;
a rotary control member of the shaft, fastened at a proximal end of the shaft and the rotation of which selectively commands the opening and closing of the conduit by the closing flap; and
a torsional return spring of the rotary control member,
a stop being provided at one distal end of the shaft, opposite the proximal end, to keep the closing flap in an axial position in the conduit by cooperation with the valve body, against a force of the return spring,
the stop including a flat washer fastened on the lateral end of the shaft, the lateral end on which the flat washer is fastened having a circular groove, the weld bead between the lateral end of the shaft and the flat washer being received in the groove.

2. The valve according to claim 1, wherein the lateral end on which the flat washer is fastened has a centering lug, the groove being formed at the base of the centering lug.

3. The valve according to claim 1, wherein a distal bearing guiding the rotation of the shaft relative to the valve body is inserted between the flat washer and the valve body, the flat washer keeping the distal bearing in contact against the valve body.

4. The valve according to claim 3, wherein the valve body has a shoulder forming a housing receiving the distal bearing.

5. The valve according to claim 1, comprising a proximal bearing guiding the rotation of the shaft relative to the valve body, opposite the flat washer relative to the closing flap, a seal being arranged axially between the proximal bearing and the valve body.

6. The valve according to claim 1, comprising a bush guiding the rotation of the shaft relative to the valve body, with an integrated seal opposite the flat washer relative to the closing flap.

7. A method for manufacturing a fluid circulation valve for a motor vehicle as claimed in claim 1, comprising:
molding a valve body having a conduit to be closed off using a closing flap;
inserting a shaft into the valve body so that the closing flap is received in the conduit; and
fastening a flat washer on a lateral end of the shaft opposite a control member.

8. The method according to claim 7, wherein the washer is welded on the lateral end of the shaft, the weld seam being formed in a groove.

9. The method according to claim 7, wherein, during the welding, a force pressing the washer on the valve body or a distal bearing and a force pressing the shaft on the flat washer are applied, the force pressing the flat washer on the valve body, or the distal bearing, being greater than the force pressing the shaft on the flat washer.

10. The method according to claim 7, further comprising a step for forming a centering lug on the lateral end of the shaft configured as the opposite end of the shaft relative to the control member, and a groove at the base of the lug.
